(19) United States
(12) Patent Application Publication
(10) Pub. No.: US 2025/0210635 A1
(43) Pub. Date: Jun. 26, 2025

(54) POSITIVE ELECTRODE MATERIAL, METHOD FOR PREPARING SAME, AND LITHIUM-ION SECONDARY BATTERY COMPRISING SAME

(71) Applicant: MURATA MANUFACTURING CO., LTD., Kyoto (JP)

(72) Inventors: Yuli LI, Shanghai (CN); Siming YANG, Shanghai (CN); Kazumasa TAKESHI, Shanghai (CN)

(21) Appl. No.: 19/069,959

(22) Filed: Mar. 4, 2025

Related U.S. Application Data
(63) Continuation of application No. PCT/CN2023/114270, filed on Aug. 22, 2023.

(30) Foreign Application Priority Data
Oct. 31, 2022 (CN) 2022113443074

(51) Int. Cl. H01M 4/36; H01M 4/02; H01M 4/131; H01M 4/525; H01M 10/0525

(52) U.S. Cl. CPC H01M 4/366; H01M 4/131; H01M 4/525; H01M 10/0525; H01M 2004/021; H01M 2004/028

(57) ABSTRACT

A positive electrode material for a lithium-ion battery, a method for preparing same, and a lithium-ion secondary battery including same. The positive electrode material includes a high-nickel material and a coating layer on the surface of the high-nickel material, wherein the coating layer comprises compound CₓH_{y-n}O_{z}Liₙ (I) of formula (I) and compound CₓH_{y-n-1} O_{z}Liₙ₊₁ (II) of formula (II), wherein x, y, z and n are each independently integers where 1≤x≤10, 2≤y≤20, 2≤z≤12, and 1≤n≤3.

### CROSS REFERENCE TO RELATED APPLICATIONS

The present application is a continuation of International patent application no. PCT/CN2023/114270, filed on Aug. 22, 2023, which claims priority to Japanese patent application no. 2022113443074, filed on Oct. 31, 2022, the entire contents of which are incorporated herein by reference.

### BACKGROUND

The present disclosure relates to the field of lithium-ion secondary batteries, and in particular, to a positive electrode material for a lithium-ion battery, a method for preparing same, and a lithium-ion secondary battery comprising same.

In recent years, with the continuous updating of electronic technology, the demand for battery devices used to support energy supply for electronic devices has also been increasing. Nowadays, there is a need for batteries that can store more electricity and output high power. Traditional lead-acid batteries and Nickel-metal hydride batteries, etc., can no longer meet the requirements of new electronic products. Therefore, lithium batteries have attracted widespread attention. During the development of lithium battery, its capacity and performance have been effectively improved.

In the lithium battery technologies, high-nickel materials are currently the main development direction of positive electrode materials due to their higher energy density, and are widely used in the field of power batteries. However, the residual alkali (including LiOH and Li₂CO₃) on the surface of high-nickel materials will increase with the increase of nickel content, resulting in poor processing performance. Moreover, residual alkali can lead to gas production in batteries. The more lithium impurities there are, the more severe the gas production becomes. Therefore, reducing the residual alkali content on the surface of high-nickel materials has become a current research focus.

Indeed, the surface residual alkali of the conventional water washing modified high-nickel materials decrease significantly, but the surface of the water washing modified materials will generate NiO-like substances, leading to an increase in battery impedance and the precipitation of lattice lithium out of the material, resulting in unstable material structure and significantly deteriorated cycle performance.

### SUMMARY

The present disclosure, in an embodiment, relates to providing a positive electrode material for a lithium battery, a method for preparing same, and a lithium-ion secondary battery comprising same, in order to solve the problems of increased battery impedance and deteriorated cycle performance caused by methods for reducing the residual alkali content on the surface of high-nickel materials.

In an embodiment, the present disclosure provides a high-nickel material with very low residual alkali content on the surface of the material and having RCOOLi based substances on the surface as a coating layer. The coating layer can stabilize the structure of the material, reduce impedance, thereby greatly improving the cycle performance of the material.

According to one aspect of the present disclosure, the present disclosure provides a positive electrode material for a lithium-ion battery, comprising a high-nickel material; and a coating layer on the surface of the high-nickel material, wherein the coating layer comprises a compound of formula (I)

CₓH_{y-n}O_{z}Liₙ (I)
and a compound of formula (II)

CₓH_{y-n-1}O_{z}Liₙ₊₁ (II),
wherein x, y, z and n are each independently integers where 1≤x≤10, 2≤y≤20, 2≤z≤12, and 1≤n≤3.

Further, in the above positive electrode material, the compound of formula (I) and the compound of formula (II) are Li salts of organic acids, which have the general formula of CₓH_{y}O_{z}, wherein x, y, and z are each independently integers where 1≤x≤10, 2≤y≤20, 2≤z≤12, and the organic acid contains 1 to 3 carboxyl groups and 0 to 1 C═C double bond according to an embodiment.

Further, in the above positive electrode material, the organic acids include one or more of maleic acid, acrylic acid, fumaric acid, malonic acid, oxalic acid, malic acid, glycolic acid, succinic acid, citric acid, tricarballylic acid, and aconitic acid, preferably one or more of maleic acid, malonic acid, and oxalic acid, and most preferably maleic acid according to an embodiment.

Further, in the above positive electrode material, the molar percentage a of the compound of formula (I) in the coating layer is 50%≤a<100%, and the molar percentage b of the compound of formula (II) in the coating layer is 0%<b≤50%, preferably 1≤a/b≤3 according to an embodiment.

Further, in the above positive electrode material, the coating layer is uniformly covered on the surface of the high-nickel material according to an embodiment.

Further, in the above positive electrode material, the thickness of the coating layer is 1-100 nm, and the mass fraction of the coating layer in the high-nickel material is 0.1-10 wt %, preferably 1-5 wt % according to an embodiment.

Further, in the above positive electrode material, the coating layer exists on both of the surface of the secondary particles and the grain boundary of the primary particles of the high-nickel material according to an embodiment.

Further, in the above positive electrode material, the high-nickel material has a general formula of LiNiₘMₙO₂, wherein m+n=1, 0.6≤m≤1, 0≤n≤0.4, and M is one or more of Co, Mn, Al, Mg, Ti, Fe, Cu, Zn, Ga, Zr, Mo, Nb and W according to an embodiment.

According to another aspect of the present disclosure, the present disclosure provides a method for preparing a positive electrode material as described in any one of the above aspects, comprising the steps of: mixing an organic acid with a non-aqueous solvent to obtain an organic acid solution; adding the high-nickel material to the organic acid solution and stirring to obtain a mixed solution; suction filtering the mixed solution to obtain a mixture; and vacuum drying, grinding, and sieving the mixture to obtain the positive electrode material; wherein, the coating layer is generated by the reaction between the organic acid and LiOH and/or Li₂CO₃ contained in the high-nickel material.

Further, in the above method, the pKa of the organic acid is 1-5 according to an embodiment.

Further, in the above method, the organic acid includes one or more of maleic acid, acrylic acid, fumaric acid, malonic acid, oxalic acid, malic acid, glycolic acid, succinic acid, citric acid, tricarballylic acid, and aconitic acid according to an embodiment.

Further, in the above method, the organic acid is one or more of maleic acid, malonic acid, and oxalic acid, preferably maleic acid according to an embodiment.

Further, in the above method, the non-aqueous solvent includes one or more of methanol, ethanol, isopropanol, ethylene glycol, and glycerol according to an embodiment.

Further, in the above method, the mass fraction of the organic acid in the organic acid solution is 0.1 wt % to 35 wt %, the mass ratio of the high-nickel material to the organic acid solution is 1:0.2-1:5, and the molar ratio of the total Li content in LiOH and/or Li₂CO₃ contained in the high-nickel material to the organic acid in the organic acid solution is 1:0.1-1:4 according to an embodiment.

Further, in the above method, the stirring is carried out at a speed of 50-500 rpm for 0.1-8 hours, the vacuum drying is carried out at a temperature of 60-150° C. for 0.1-12 hours, and the sieve size used for sieving is 50-500 mesh according to an embodiment.

According to another aspect of the present disclosure, the present disclosure provides a lithium-ion secondary battery comprising a positive electrode plate, a negative electrode plate, a separator, and an electrolyte, wherein the positive electrode plate comprises a positive electrode material according to any one of the above aspects or prepared by a method according to any one of the above aspects.

By using the positive electrode material for a lithium battery of the present disclosure, the method for preparing same, and the lithium-ion secondary battery comprising same, the effect of reducing residual alkali in the high-nickel positive electrode materials while improving impedance and cycle performance has been achieved according to an embodiment.

### BRIEF DESCRIPTION OF THE FIGURES

The accompanying drawings of the description, which form a part of the present application, are used to provide a further understanding of the present disclosure according to an embodiment.

FIG. 1 is a schematic diagram of the reaction process between an organic acid and a residual alkali in an embodiment of the present disclosure.

FIG. 2 is a graph showing the cycle retention rate vs. cycle number of batteries prepared according to examples of the present disclosure and comparative examples.

FIG. 3 shows the ToF-SIMS spectrum of the positive electrode material prepared according to Example 1 of the present disclosure.

FIG. 4 shows the ToF-SIMS spectrum of the positive electrode material prepared according to Comparative example 3.

### DETAILED DESCRIPTION

It should be noted that the examples and features in the examples in the present application can be combined with each other without conflicting. The present application will be described in further detail below including with reference to the accompanying drawings and in combination with examples according to an embodiment.

As explained in the background section, water washing modification is used to reduce residual alkali on the surface of high-nickel materials, however the surface of the water washing modified materials will generate NiO-like substances, leading to an increase in battery impedance and the precipitation of lattice lithium out of the material, resulting in unstable material structure and deteriorated cycle performance.

Targeting at the above problems, the present disclosure, in an embodiment, provides a positive electrode material for a lithium battery, wherein the high-nickel material is washed with an organic acid solution, and the organic acid reacts with the residual alkali on the surface of the material, eliminating the residual alkali and generating a substance with RCOOLi structure at the same time, which can be coated on the surface of the high-nickel material. The high-nickel positive electrode material of the present disclosure has been washed with an organic acid, leaving only trace amounts of alkaline substances on the surface, and also has good stability. The RCOOLi substance generated by the reaction between an organic acid and an alkali can reduce impedance, and the cycle performance can be greatly improved as well.

According to an embodiment of the present application, provided is a positive electrode material for a lithium-ion battery, comprising a high-nickel material; and a coating layer on the surface of the high-nickel material, wherein the coating layer of the R—Li structure comprises a compound of formula (I)

CₓH_{y-n}O_{z}Liₙ (I)
and a compound of formula (II)

CₓH_{y-n-1}O_{z}Liₙ₊₁ (II),
wherein x, y, z and n are each independently integers where 1≤x≤10, 2≤y≤20, 2≤z≤12, and 1≤n≤3.

In a preferred embodiment, the high-nickel material has a general formula of LiNiₘMₙO₂, wherein m+n=1, 0.6≤m≤1, 0≤n≤0.4, and M is one or more of Co, Mn, Al, Mg, Ti, Fe, Cu, Zn, Ga, Zr, Mo, Nb and W.

In the field, during the preparation of the high-nickel materials, the ratio of lithium to metal is slightly increased (i.e., the lithium salt is appropriately excessive) to compensate for the losses caused by the sintering process. Therefore, there will be residual Li in the produced high-nickel materials, which mainly exists in the form of Li₂O, and is liable to reaction with CO₂ and H₂O in the air to generate Li₂CO₃ and LiOH. In addition, the higher the nickel content in the high-nickel material, the more LiNiO₂ there is in the material, and LiNiO₂ can also react with H₂O to generate LiOH, producing more LiOH.

In order to reduce the residual alkali in the high-nickel materials, the inventors unexpectedly found that by washing the high-nickel materials with a specific organic acid, the residual alkali on the surface of the high-nickel materials can be removed. At the same time, compounds generated by the reaction between an organic acid and the residual alkali can form a coating layer of RCOOLi substance on the surface of the high-nickel materials, and the above-mentioned coating layer according to the present disclosure can achieve the effect of reducing impedance and improving cycle performance according to an embodiment.

RCOOLi substance is a mixture of the product of complete reaction (i.e. a compound of formula (II)) between an organic acid and the alkali and the product of incomplete reaction (i.e. a compound of formula (I)), and an optimal coating effect is achieved when both are present simultaneously. If all of the RCOOLi substances are the product of complete reaction, the reaction will consume the lithium in the lattice of the positive electrode material, so that the active lithium in the material itself is reduced, leading to a decrease in capacity. If all of the RCOOLi substances are the product of incomplete reaction, the ionic conductivity will be deficient, and the impedance performance will be affected.

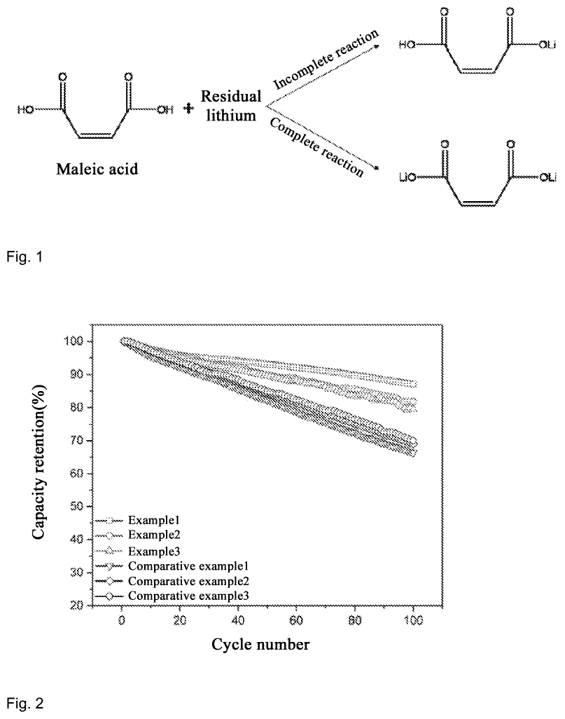

For example, as shown in FIG. 1, where the residual alkali reacts with maleic acid, the products of complete and incomplete reactions as shown in the figure will be generated.

In an embodiment of the present application, the compound of formula (I) and the compound of formula (II) are Li salts of an organic acid, which has the general formula of CₓH_{y}O_{z}, wherein x, y, and z are each independently integers where 1≤x≤10, 2≤y≤20, and 2≤z≤12, and the organic acid contains 1 to 3 carboxyl groups and 0 to 1 C═C double bond.

As described above, the coating layer of the present disclosure is the product of the reaction between an organic acid and the residual lithium (including Li₂CO₃ and LiOH), namely the Li salt of an organic acid, wherein the organic acid has the general formula of CₓH_{y}O_{z}. The inventors also found that the organic acid containing 1 to 3 carboxyl groups and 0 to 1 C═C double bond is helpful to the formation of the coating layer of the present disclosure.

In a preferred embodiment of the present application, the organic acids include one or more of maleic acid, acrylic acid, fumaric acid, malonic acid, oxalic acid, malic acid, glycolic acid, succinic acid, citric acid, tricarballylic acid, and aconitic acid, preferably one or more of maleic acid, malonic acid, and oxalic acid, and most preferably maleic acid.

In an embodiment of the present application, the molar percentage a of the compound of formula (I) in the coating layer is 50%≤a<100%, and the molar percentage b of the compound of formula (II) in the coating layer is 0%<b≤50%, preferably 1≤a/b≤3.

As mentioned above, the reaction between an organic acid and an alkali produces a product of complete reaction (i.e. a compounds of formula (II)) and a product of incomplete reaction (i.e. a compounds of formula (I)). The inventors have found that an appropriate ratio between the two can help to achieve the optimal coating effect. If the above ratio a/b is less than 1, it indicates that there are more products of complete reaction, which will consume additional lithium in the lattice of the positive electrode material, resulting in a decrease in capacity of the material. If the ratio a/b is greater than 3, it indicates that there are more products of incomplete reaction, which will lead to a decrease in the ionic conductivity of the coating layer, affecting the impedance.

In an embodiment of the present application, the coating layer exhibits characteristic peaks in the range of 1600-1800 cm⁻¹ in FTIR, characteristic peaks in the range of 288-290 eV in XPS C1s, and fragment peaks of CₓH_{y-n-1}O_{z}Liₙ⁻ and Cₓ₋₁H_{y-n-1}O_{z-2}Liₙ⁻ in ToF-SIMS testing. The fragment peaks in the two-dimensional imaging spectrum (also known as the element distribution spectrum, mapping spectrum) of ToF-SIMS testing is shown to be uniformly covered on the surface of the high-nickel material.

The inventors have performed FTIR, XPS C1s, and ToF-SIMS tests on the positive electrode materials prepared according to the present disclosure. The characteristic peaks in the range of 1600-1800 cm⁻¹ in FTIR represent C═O, the peaks in the range of 285-287 eV in XPS represent C═O, and the peaks in the range of 288-290 eV in XPS represent COOR. Therefore, the above tests have verified the presence of the above compounds of formulae (I) and (II) in the coating layers of the positive electrode materials prepared in the present disclosure, and the coating layers are uniformly covered on the surface of the high-nickel material.

In an embodiment of the present application, the thickness of the coating layer is 1-100 nm, and the mass fraction in the high-nickel material is 0.1-10 wt %, preferably 1-5 wt %. In a preferred embodiment, the coating layer exists on both of the surface of the secondary particles and the grain boundary of the primary particles of the high-nickel material.

The inventors have found through tests that when the mass fraction of the coating layer in the high-nickel material is 1-10 wt %, it is most advantageous for the performance of materials according to an embodiment. The inventors have also observed through an electron microscope that the thickness of the coating layer prepared according to the embodiments of the present disclosure is 1-100 nm. Particles of high-nickel material are large particles formed by the aggregation of multiple small particles, with the small particles being referred to as primary particles and the large particles being referred to as secondary particles. Observation shows that the coating layer of the present disclosure exists on both of the surface of the secondary particles and the grain boundary of the primary particles of the high-nickel material, once again indicating that the coating layer is uniformly covered on the particle surface of the high-nickel materials.

According to another embodiment of the present disclosure, a method for preparing a positive electrode material as described in any one of the above aspects is provided, comprising the steps of: mixing an organic acid with a non-aqueous solvent to obtain an organic acid solution; adding the high-nickel material to the organic acid solution and stirring to obtain a mixed solution; suction filtering the mixed solution to obtain a mixture; and vacuum drying, grinding, and sieving the mixture to obtain the positive electrode material; wherein, the coating layer is generated by the reaction between the organic acid and LiOH and/or Li₂CO₃ contained in the high-nickel material.

As mentioned above, the inventors have unexpectedly found that by washing the high-nickel materials with an organic acid, the organic acid can react with the residual alkali in the materials to form a coating layer covering on the surface of the high-nickel materials, which can not only remove the residual alkali but also can improve the impedance and cycle performance of the materials.

In an embodiment of the present application, the pKa of the organic acid is 1-5.

In a preferred embodiment, the organic acid includes one or more of maleic acid, acrylic acid, fumaric acid, malonic acid, oxalic acid, malic acid, glycolic acid, succinic acid, citric acid, tricarballylic acid, and aconitic acid.

In a preferred embodiment, the organic acid is one or more of maleic acid, malonic acid, and oxalic acid, preferably maleic acid.

In an embodiment of the present application, the non-aqueous solvent includes one or more of methanol, ethanol, isopropanol, ethylene glycol, and glycerol.

The inventors have found that when maleic acid, malonic acid, or oxalic acid, especially maleic acid is used for washing the high-nickel materials, an excellent performance of materials can be achieved, and using non-aqueous solvents to prepare organic acid solutions can help to reduce the impact on the impedance of materials.

In an embodiment of the present application, the mass fraction of the organic acid in the organic acid solution is 0.1 wt % to 35 wt %, the mass ratio of the high-nickel material to the organic acid solution is 1:0.2-1:5, and the molar ratio of the total Li content in LiOH and/or Li₂CO₃ contained in the high-nickel material to the organic acid in the organic acid solution is 1:0.1-1:4.

The inventors have found that when the amount of organic acid and high-nickel material used in the washing is in the above ratio range, it is beneficial to prepare materials with better performance. In particular, when the mass ratio of the high-nickel materials to the organic acid solution is too low, excess solvent is used, resulting in waste and increased costs; and when the mass ratio is too high, the high-nickel positive electrode material is difficult to uniformly disperse in the solution, affecting the uniformity of the reaction.

In an embodiment of the present application, the stirring is carried out at a speed of 50-500 rpm for 0.1-8 hours, the vacuum drying is carried out at a temperature of 60-150° C. for 0.1-12 hours, and the sieve size used for sieving is 50-500 mesh.

The inventors have found that the process conditions during the preparation of the positive electrode materials have a certain impact on the performance of the prepared materials. When the process parameters conform to the above range, it is beneficial to prepare materials with better performance.

According to another embodiment of the present disclosure, a lithium-ion secondary battery is provided, which comprises a positive electrode plate, a negative electrode plate, a separator, and an electrolyte, wherein the positive electrode plate comprises a positive electrode material according to any one of the above aspects or prepared by a method according to any one of the above aspects.

The present disclosure will be further described in further detail below in conjunction with specific examples according to an embodiment of the present disclosure.

### EXAMPLES

### Example 1

The high-nickel materials and the lithium-ion batteries used in the examples were prepared through the following steps.
(1) Weighing 2 g of maleic acid and pouring it into a beaker, adding ethanol to 100 g and stirring for 1 hour to obtain a maleic acid solution; (2) weighing 100 g of high-nickel positive electrode material (LiNi_{0.8}Co_{0.1}Al_{0.1}O₂) and adding it to the solution in step (1), stirring at 350 rpm for 1 hour to obtain a mixed solution; (3) suction filtering the mixed solution in step (2) to obtain a solid material, placing it in a vacuum drying oven and drying at 120° C. for 8 hours, then grinding and sieving (200 mesh) same to obtain the acid washed high-nickel material; (4) using 90 g of the acid washed high-nickel material prepared in step (3), 5 g of conductive carbon black as a conductive agent, and 5 g of polyvinylidene fluoride (PVDF) as a binder to make electrode plates, and using the above electrode plates to make half batteries for measuring the electrochemical performance of the batteries.

### Example 2

High-nickel materials and batteries were prepared using the same method as Example 1, except that the maleic acid was replaced with oxalic acid of the same mass.

### Example 3

High-nickel materials and batteries were prepared using the same method as Example 1, except that the maleic acid was replaced with malonic acid of the same mass.

### Example 4

High-nickel materials and batteries were prepared using the same method as Example 1, except that the maleic acid used in step (1) was 4 g.

### Example 5

High-nickel materials and batteries were prepared using the same method as Example 1, except that ethanol was added to 67 g in step (1).

### Example 6

High-nickel materials and batteries were prepared using the same method as Example 1, except that the stirring speed in step (2) was 200 rpm.

### Example 7

High-nickel materials and batteries were prepared using the same method as Example 1, except that the drying temperature in step (3) was 80° C.

### Example 8

High-nickel materials and batteries were prepared using the same method as Example 1, except that the sieve size in step (3) was 300 mesh.

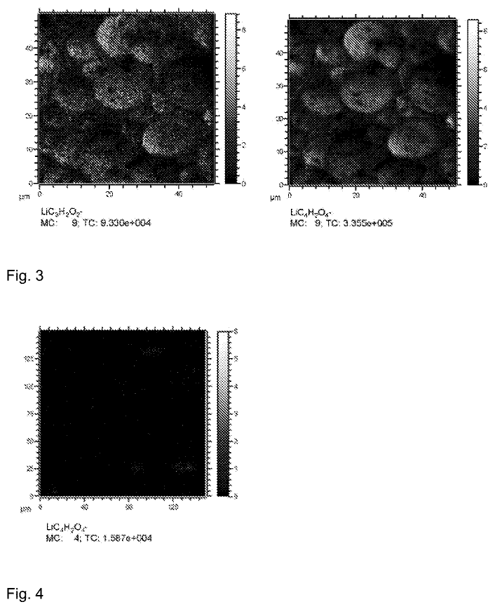

As described above, FTIR, XPS C1s, and ToF-SIMS tests were carried out on the positive electrode materials prepared according to the examples of the present disclosure, respectively. Among them, the characteristic peaks in the range of 1600-1800 cm⁻¹ showed in FTIR represented C═O, the peaks in the range of 285-287 eV showed in XPS represented C═O, and the peaks in the range of 288-290 eV showed in XPS represented COOR. Fragment peaks of CₓH_{y-n-1}O_{z}Liₙ⁻ and Cₓ₋₁H_{y-n-1}O_{z-2}Liₙ⁻ were showed in ToF-SIMS test. The fragment peaks in the two-dimensional imaging spectrum of ToF-SIMS test was shown to be uniformly covered on the surface of the high-nickel material (See FIG. 3). Therefore, the above tests have verified the presence of the above compounds of formulas (I) and (II) in the coating layers of the positive electrode materials prepared in the Examples of the present disclosure, and the coating layers were uniformly covered on the surface of the high-nickel material. Also, through the tests, it was found that the mass fraction of the coating layer prepared in the examples of the present disclosure in the high-nickel materials was 1-10 wt %. Through observation via electron microscopy, it was found that the thickness of the coating layer was 1-100 nm, and it existed on both of the surface of the secondary particles and the grain boundary of the primary particles of the high-nickel material.

### Comparative Example 1

High-nickel materials and batteries were prepared using the same method as Example 1, except that the untreated high-nickel materials were used directly to prepare the positive electrode plates and batteries.

### Comparative Example 2

High-nickel materials and batteries were prepared using the same method as Example 1, except that the organic acid solution in step (1) was replaced with 100 g of deionized water.

### Comparative Example 3

High-nickel materials and batteries were prepared using the same method as Example 1, except that (4) after step (3), adding 100 g of the acid washed high-nickel material obtained in step (3) to 100 g of deionized water and repeating steps (2) and (3) to obtain the acid washed and water washed high-nickel material; (5) using 90 g of the material prepared in step (4), 5 g of conductive carbon black as a conductive agent, and 5 g of polyvinylidene fluoride (PVDF) as a binder to make electrode plates, and using the above electrode plates to make half batteries.

The half batteries in the above examples and comparative examples were first subjected to a cycle test at 0.1 C at 25° C. for one cycle, and the initial impedance was tested after the completion of the test. Then, cycle test of charging at 1 C and discharging at 5 C was conducted for 100 cycles at 60° C. to determine the capacity retention rate of the battery after 100 cycles. After the completion of the test, the post-cycle impedance was tested. The results of the tests are as shown in Table 1 below.

TABLE 1

| | | Initial | Post-cycle | Fold of | Cycle |
|---|---|---|---|---|---|
| | Residual | impedance | impedance | impedance | retention |
| Samples | alkali | (Ω) | (Ω) | growth | rate |
| Example 1 | 0.1% | 2 | 10 | 5 | 92% |
| Example 2 | 0.15% | 2.1 | 12 | 6 | 87% |
| Example 3 | 0.18% | 2.2 | 15 | 7 | 82% |
| Example 4 | 0.1% | 2 | 10 | 5 | 92% |
| Example 5 | 0.1% | 2 | 10 | 5 | 92% |
| Example 6 | 0.1% | 2 | 10 | 5 | 92% |
| Example 7 | 0.1% | 2 | 10 | 5 | 92% |
| Example 8 | 0.1% | 2 | 10 | 5 | 92% |
| Comparative | 0.5% | 3 | 120 | 40 | 66% |
| example 1 | | | | | |
| Comparative | 0.2% | 10 | 600 | 60 | 69% |
| example 2 | | | | | |
| Comparative | 0.1% | 11 | 700 | 64 | 70% |
| example 3 | | | | | |

* Fold of impedance growth = post-cycle impedance/initial impedance

In the results of Table 1, it can be seen from the comparison between Examples 1-8 and Comparative Examples 1-3 that the positive electrode materials according to the present disclosure and the positive electrode materials prepared by the method according to the present disclosure, with a coating layer comprising compounds of formulas (I) and (II) on the surface of the high-nickel material, comparing with the untreated high-nickel materials, high-nickel materials treated with water washing, and high-nickel materials washed with water after acid washing, has lower level of residual alkali, and has significant improvements in terms of impedance growth and capacity retention rate. Such a high-nickel positive electrode material with a coating layer of specific composition on its surface has not been described in the prior art. In addition, FIG. 2 shows a graph of capacity retention rate vs. cycle number of Example 1 and Comparative example 1. It can be seen therefrom that the positive electrode material according to the present disclosure has a significant improvement in capacity retention rate compared to the untreated high-nickel materials, high-nickel materials treated with water washing, and high-nickel materials washed with water after acid washing. FIG. 4 shows the ToF-SIMS spectrum of the positive electrode material prepared according to Comparative Example 3. It can be seen therefrom that in the case of further washing the acid washed high-nickel material with water, no coating layer of the present disclosure exists on the surface of the high-nickel material. Considering that all of the methods for removing the residual alkali from the surface of high-nickel materials in the prior art adopt water washing treatment of the high-nickel materials, or water washing treatment of the high-nickel materials after acid washing, the method of preparing modified high-nickel materials through acid washing in the present disclosure has achieved unexpectedly improved impedance growth and capacity retention rate.

In addition, Examples 1-3 demonstrate that the specific organic acids specified in the present disclosure can achieve the technical effects of reducing residual alkali, improving impedance growth and capacity retention rate, and maleic acid can achieve the optimal technical effect. Examples 1, 4, and 5 demonstrate that the mass fraction of organic acids in the solution within the specific range specified in the present disclosure, as well as the mass ratio of high-nickel materials to organic acid solutions, can achieve better technical effects. Examples 1 and 6-8 demonstrate that stirring speed, drying temperature, and sieve size within the specific range specified in the present disclosure can achieve better technical results.

In summary, by using the positive electrode materials according to the present disclosure and the positive electrode materials prepared by the method according to the present disclosure, improvements have been achieved in terms of impedance growth and capacity retention rate while reducing the residual alkali levels compared with the positive electrode materials in the existing technology.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A positive electrode material for a lithium-ion battery, comprising:
a high-nickel material; and
a coating layer on a surface of the high-nickel material, wherein the coating layer comprises:
a compound of formula (I)
CₓH_{y-n}O_{z}Liₙ (I)
and a compound of formula (II)
CₓH_{y-n-1}O_{z}Liₙ₊₁ (II),
wherein x, y, z and n are each independently integers where 1≤x≤10, 2≤y≤20, 2≤z≤12, and 1≤n≤3.

2. The positive electrode material according to claim 1, wherein the compound of formula (I) and the compound of formula (II) are Li salts of organic acids, wherein the organic acids have a general formula of CₓH_{y}O_{z}, where x, y, and z are each independently integers, where 1≤x≤10, 2≤y≤20, 2≤z≤12, and where the organic acids contain 1 to 3 carboxyl groups and 0 to 1 C=C double bond.

3. The positive electrode material according to claim 2, wherein the organic acids comprise one or more of maleic acid, acrylic acid, fumaric acid, malonic acid, oxalic acid, malic acid, glycolic acid, succinic acid, citric acid, tricarballylic acid, and aconitic acid.

4. The positive electrode material according to claim 1, wherein the molar percentage a of the compound of formula (I) in the coating layer is 50%≤a<100%, and the molar percentage b of the compound of formula (II) in the coating layer is 0%<b≤50%.

5. The positive electrode material according to claim 1, wherein the coating layer is uniformly covered on the surface of the high-nickel material.

6. The positive electrode material according to claim 1, wherein a thickness of the coating layer is 1-100 nm, and a mass fraction of the coating layer in the positive electrode material is 0.1-10 wt %.

7. The positive electrode material according to claim 1, wherein the coating layer exists on both of a surface of secondary particles and a grain boundary of primary particles of the high-nickel material.

8. The positive electrode material according to claim 1, wherein the high-nickel material has a general formula of LiNiₘMₙO₂, where m+n=1, 0.6≤m≤1, 0≤n≤0.4, and where M is one or more of Co, Mn, Al, Mg, Ti, Fe, Cu, Zn, Ga, Zr, Mo, Nb and W.

9. A method for preparing a positive electrode material, comprising:
mixing an organic acid with a non-aqueous solvent to obtain an organic acid solution;
adding a high-nickel material to the organic acid solution and stirring to obtain a mixed solution;
suction filtering the mixed solution to obtain a mixture; and
vacuum drying, grinding, and sieving the mixture to obtain the positive electrode material;
wherein a coating layer is generated on a surface of the high-nickel material by a reaction between the organic acid and one or both of LiOH and Li₂CO₃ contained in the high-nickel material.

10. The method according to claim 9, wherein the pKa of the organic acid is 1-5.

11. The method according to claim 9, wherein the organic acid comprises one or more of maleic acid, acrylic acid, fumaric acid, malonic acid, oxalic acid, malic acid, glycolic acid, succinic acid, citric acid, tricarballylic acid, and aconitic acid.

12. The method according to claim 11, wherein the organic acid is one or more of maleic acid, malonic acid, and oxalic acid.

13. The method according to claim 9, wherein the non-aqueous solvent comprises one or more of methanol, ethanol, isopropanol, ethylene glycol, and glycerol.

14. The method according to claim 9, wherein a mass fraction of the organic acid in the organic acid solution is 0.1 wt % to 35 wt %, a mass ratio of the high-nickel material to the organic acid solution is 1:0.2-1:5, and a molar ratio of the total Li content in one or both of LiOH and Li₂CO₃ contained in the high-nickel material to the organic acid in the organic acid solution is 1:0.1-1:4.

15. The method according to claim 9, wherein stirring is carried out at a speed of 50-500 rpm for 0.1-8 hours, vacuum drying is carried out at a temperature of 60-150° C. for 0.1-12 hours, and a sieve size used for sieving is 50-500 mesh.

16. A lithium-ion secondary battery comprising a positive electrode plate, a negative electrode plate, a separator, and an electrolyte, wherein the positive electrode plate comprises the positive electrode material according to claim 1.
